(19) United States
(12) Patent Application Publication
(10) Pub. No.: US 2013/0316809 A1
(43) Pub. Date: Nov. 28, 2013

(54) METHOD AND SYSTEM FOR ONLINE WAGERING COMPLIANCE

(71) Applicant: CAMS, LLC, Los Angeles, CA (US)

(72) Inventors: Matthew G. Katz, Los Angeles, CA (US); Jeffrey Sawitke, Mentor, OH (US)

(73) Assignee: CAMS, LLC, Los Angeles, CA (US)

(21) Appl. No.: 13/901,527

(22) Filed: May 23, 2013

Related U.S. Application Data
(60) Provisional application No. 61/650,970, filed on May 23, 2012.

(51) Int. Cl. G07F 17/32

(52) U.S. Cl. CPC G07F 17/3241
USPC 463/29

(57) ABSTRACT

Techniques for facilitating online wagering or service compliance are disclosed herein. In one example, there is provided a central account management system having at least one entity configured to access user information for a user, the user information comprising identification information and/or payment information. The entity may be configured to monitor account activity of the user across at least one online service, and obtain account restrictions for the user from a database based on the user information. The entity may be configured to facilitate compliance with the account restrictions based on the account activity.

### CROSS-REFERENCE TO RELATED APPLICATION

The present Application for Patent claims priority to the Provisional Application No. 61/650,970, filed May 23, 2012, entitled “METHOD AND SYSTEM FOR ONLINE WAGERING COMPLIANCE”, which is assigned to the assignee hereof and hereby expressly incorporated in its entirety by reference herein.

### BACKGROUND

1. Field

The present application relates generally to managing online service accounts, and more specifically to methods and systems for managing online wagering accounts.

2. Background

The Internet has made way for new types of online services, many of which involve having a user establish an online service account in order to use the service offered at a given online service website. The various types of online services may include, but are not limited to, email, shopping, social networking, content access, wagering, etc. Online wagering or gambling services may include, for example, poker, casino games (e.g., roulette, blackjack, pachinko, baccarat), sports betting, horse race betting, bingo, lotteries, in-play gambling, or the like.

Some online services (e.g., online wagering) introduce various issues, such as, regulatory compliance, fraud and risk mitigation, user/player accounts limits, payout management, gambling addiction, or the like. Moreover, the handling of such issues may be ineffective if the bodies/agencies responsible for handling such issues are disorganized or do not communicate with each other. Accordingly, there is a need for a central account management system for such online services.

### SUMMARY

Illustrative embodiments of the present invention that are shown in the drawings are summarized below. These and other embodiments are more fully described in the detailed description section. It is to be understood, however, that the invention is not limited to the forms described in this Summary of the Invention or in the detailed description.

In accordance with one or more aspects of the embodiments described herein, there is provided a method for managing online service account(s). The method may be operable by a central account management system or component(s) thereof. The method may involve accessing user information for a user (e.g., collecting the user information from the user or a third-party entity), the user information comprising identification information and/or payment information. The method may involve monitoring account activity of the user across at least one online service. The method may involve obtaining account restrictions for the user from a database based on the user information. The method may involve facilitating compliance with the account restrictions based on the account activity. In further related aspects, an electronic device (e.g., a specialized server) or component(s) thereof may be configured to execute the above described methodology.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates an exemplary network that includes a central account management system.

FIG. 2 illustrates an exemplary system for generating and managing user profiles.

FIG. 3 illustrates an exemplary user profile.

FIG. 4 illustrates an exemplary system for registering new users.

FIG. 5 illustrates an exemplary system for authenticating returning users.

FIG. 6 illustrates an exemplary system for funding Operator accounts.

FIG. 7 illustrates an embodiment of a system for coordinating the deposit payment process.

FIG. 8 illustrates another embodiment of a system for coordinating the deposit payment process.

FIG. 9 illustrates an embodiment of a system for coordinating the withdrawal process.

FIG. 10 illustrates an embodiment of a system for coordinating the withdrawal process, wherein the central account management system is not providing payment connectivity to banking networks.

FIG. 11 shows one embodiment of a method for managing online service account(s).

FIG. 12 illustrates one embodiment of an apparatus for managing online service account(s), in accordance with the methodology of FIG. 11.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As used herein, the term exemplary refers to an embodiment that serves an example or illustration of a given concept, and does not necessarily refer to a best mode or a preferred mode.

In accordance with one or more aspects of the embodiments described herein, there is provided a method and system for managing service accounts, via one or more network entities configured for the central account management of online services. For example, a given network entity may be referred to as a central account management entity or network entity herein, and may be one or more server(s) or the like, and may include a multi-tenant Software as a Service (SaaS) management platform. The central account management entities may be collectively referred to as a central account management system, wherein the entities may handle the communication of data in a synchronous or asynchronous manner, depending on the context or application.

As used herein, Partner or Partner instance may refer to an entity that uses or implements an instance or version of the central account management system or the like. The Partner may optionally use or tailor their instance or version of the central account management system to engage in industry best practices or facilitate compliance with rules, laws, regulations, etc. For example, the Partner may use the system to facilitate identifying, monitoring, or managing compliance with regulations and rules across one or more industries, such as, for example, online wagering, online gambling, etc. As used herein, an Operator may refer to any entity that integrates its online service, website, and/or software with the Partner's instance of the central account management system platform, which may be a multitenant platform running on one or more server(s), device(s), processor(s), or component(s) thereof, in operative communication with each other via wired and/or wireless network(s). The Operator may abide by the Partner's system standards or the like. As used herein, a user may refer to an end customer of the Operator. The user may use or interact with the Operator's online service or software, and may be identified, monitored, or managed by the Partner's instance of the platform.

IDENTITY MANAGEMENT: User information may be collected by the Operator and inputted into the central account management system. For example, the collected information may include but is not limited to the following: social security number, driver's license number, government ID, passport number, credit score data, tax return data, background check data, personally identifiable information (PII), a user device ID, voiceprint, fingerprint, facial print, retinal print, hand print, casino-operator specific account data, or geo-location data for the user, etc. The user information may include such identification information and/or payment information.

In related aspects, during the user identification process, information related to the user's device used to access the online service or software may be collected. Financial payment information may also be collected and linked to the user. Out of pocket/challenge response questions may be used to further validate the information provided by the user. Third-party databases may be utilized. Third-party vendors providing services such as, for example, device ID, internet protocol (IP) geo-location, Knowledge Based Authentication (KBA), multi-factor authentication, or the like, may be utilized.

In further related aspects, the user information may be collected across Operators to generate a profile for the user. The profile may link multiple user accounts across one or more Operators, across one or more Partners, across one or more access devices, and across one or more financial forms or payment for each given user.

For example, in the exemplary context of online gaming, the user limits may be predefined by federal or state regulator(s), a consortium of online Operators, individual Operators, or the like, and may include self-imposed limits by the end user, best practices, etc. Additional user screening and due diligence may be implemented to adjust user limits. This screening may take into consideration the following: background checks; submission of additional PII; submission of personal tax returns; credit score check.

PAYMENTS MANAGEMENT: The central account management system may be configured to enable Operators to accept multiple forms of payment in multiple currencies across multiple payment channels or transaction types, including but not limited to: credit and debit card, ACH/eChecks, mail order/telephone order (MOTO) transactions, e-commerce, retail, kiosk, mobile, PayPal, Digital Wallets, mobile billing, near field communication (NFC) account data, local exchange carrier (LEC) billing, Bitcoins, or the like, as well as other emerging forms of currency. The central account management system may be configured to enable Operators to manage taxation related to account funding, withdrawals, net withdrawals, or the like.

COMPLIANCE MANAGEMENT AND ACCOUNT RESTRICTIONS: Partners may be able to set compliance parameters and account restrictions. Participating Operators and their users may be evaluated against compliance parameters, such as, for example: (a) user account deposit limit of $Y dollars across participating Operators within X amount of time for the User Level; (b) alternate account restrictions for alternate user levels; (c) game play limit restrictions based on the amount of time a user spends at a given Operator's online service or on the given Operator's software (e.g., 12 hours of play in a 24 hour time period); and/or (d) user's physical location or geo-location.

Account restrictions may be enforced in real-time by the central account management system. The enforced account restrictions may include, for example: account deposit restrictions; account withdrawal restrictions; game play restrictions; user account login/authentication restrictions; restrictions based on appearance of the user on a negative database or database of blacklisted customers/users; etc. Account restrictions may also be enforced in non-real-time, such as when the system receives player information from a first Operator. The system may receive information from a second Operator minutes later. The system may transmit notifications to both Operators to take action in response to detecting one more violations of account restrictions.

Financial restrictions may be enforced by a pre-screening of the request in the central account management system if the system is not used for financial funding or withdrawals. In other words, if a service site (e.g., a gaming site) does not want to run their payments through the system, then they can pre-screen the request through the system. The request may be denied or allowed based at least in part on the pre-screen by the system. The service site would use pre-screening response information returned from the central account management system to enforce the account restrictions.

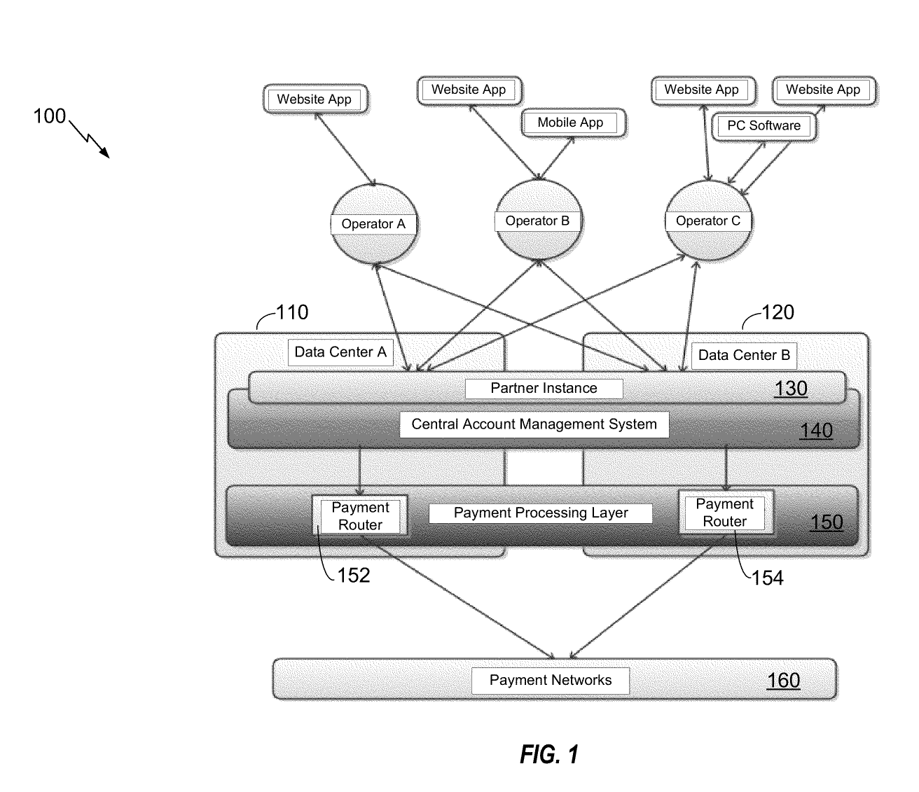

CENTRAL ACCOUNT MANAGEMENT SYSTEM OVERVIEW: FIG. 1 provides a high level overview an exemplary system 100 in which such one or more central account management system entities may be deployed. The system 100 relates to online gaming or wagering. It is noted that the principles illustrated in the system 100 are applicable to other online service sites. As shown, the Operators—i.e., Operators A, B, and C—represent gaming providers (e.g., casinos offering online gambling). Each Operator may be in operative communication with a website application (“app”), a mobile app, a tablet app, and/or personal computer (PC) software. Further, each Operator is in operative communication with a Partner instance 130 of the central account management system 140 using synchronous and asynchronous methods of communication. The Partner instance 130 may be a white-labeled or customized version of a central account management system 140 (e.g., customized for the state of Nevada). The Partner instance 130 and the system 140 may function as a clearinghouse system for online services and associated online transactions.

In the example of FIG. 1, the Partner instance 130 is illustrated as being co-located with the platform 140. It is noted, however, that the Partner instance 130 and the central account management system 140 may be in different locations, depending on the particular embodiment or application. The central account management system 140 may include or be in operative communication with a payment processor layer 150, wherein the payment processor layer 150 may include one or more payment routers (152 and 154) across one or more data centers (Data Centers A (110) and B (120) in the present example). The payment routers 152 and 154 (in the payment processor layer 150) may be in operative communication with the payment network(s) 160.

In the example of FIG. 1, the Partner instance 130 and the central account management system 140 are multi-tenant and located across Data Centers A (110) and B (120). It is noted, however, that the Partner instance 130 and the central account management system 140 may be located at a single data center or the like. Operators A, B, and/or C may connect with the Partner instance 130 of the central account management system to allow enforcement and monitoring of the Operator's user profiles across one or more Partners. The Operator's user activities may be audited across multiple channels, including, for example, website applications, mobile applications, and software installed on personal computing devices.

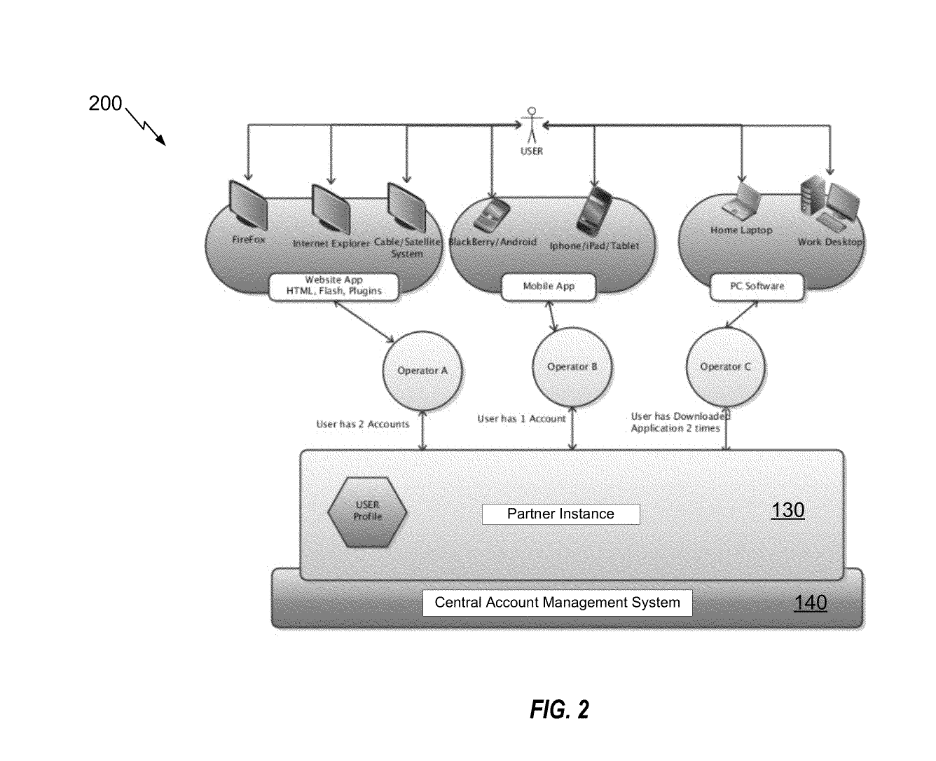

USER PROFILE: With reference to FIG. 2, there are shown features of an example system 200 for generating a central account management system profile for a user. In one approach, the central account management system 140 is not responsible for establishing and managing individual user accounts on behalf of the Operators A, B, and/or C. Rather, the Operators may deploy their own user provisioning and account management. The central account management system 140 may take the Operator user account parameters into consideration when creating the profile for the user. For example, the profile may include the following: Operator user account information; user device characteristics; device linking; account linking across websites/software applications from different providers/Operators; Internet Protocol (IP), WiFi (based on the Institute of Electrical and Electronics Engineers' (IEEE) 802.11 standards), or Mobile geo-location data; account usage history; payment activity; user information (e.g., voice print, facial recognition scans, or the like); authentication activity; and/or the like. In another approach (not shown), in addition to creating a user profile, the central account management system may also be involved with establishing and managing individual user accounts on behalf of one or more of the Operators.

It is noted that the Operators A, B, and/or C may be responsible for collecting the user information, and may provide the collected user information to the central account management system 140 or another Partner instance of the central account management system. In the alternative, or in addition, the online services or sites may collect user information, and may provide the collected user information to the central account management system 140 or the like. In the alternative, or in addition, the central account management system 140 or the like may collect the user information from end users and/or from third-party entities.

In the example shown in FIG. 2, in system 200, the user profile may be generated and stored in the Partner instance 130 of the central account management system 140. The user may utilize the services of Operator A via website app(s) and mobile app(s). The user may utilize the services of Operator B via mobile app(s), and may utilize the services of Operator C via PC software. Examples of information used to create or included in the user profile may include the number of accounts the user has with each of the Operators and how many times the user has downloaded an app for a given Operator.

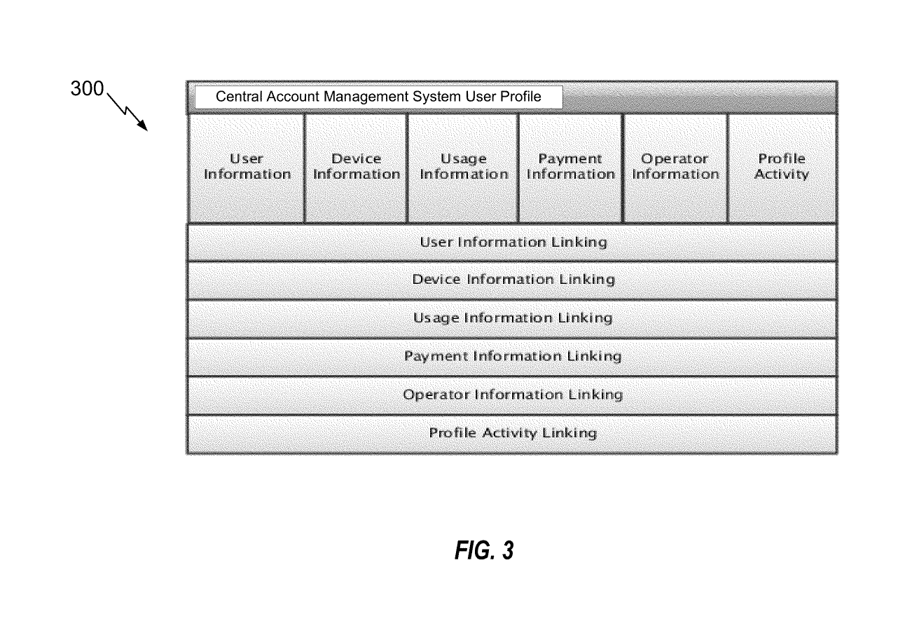

As shown in the example of FIG. 3, the user profile may include: user information; device information; usage information; payment information; Operator information; and/or profile activity. The user profile may also include linking for one or more of the above-listed information.

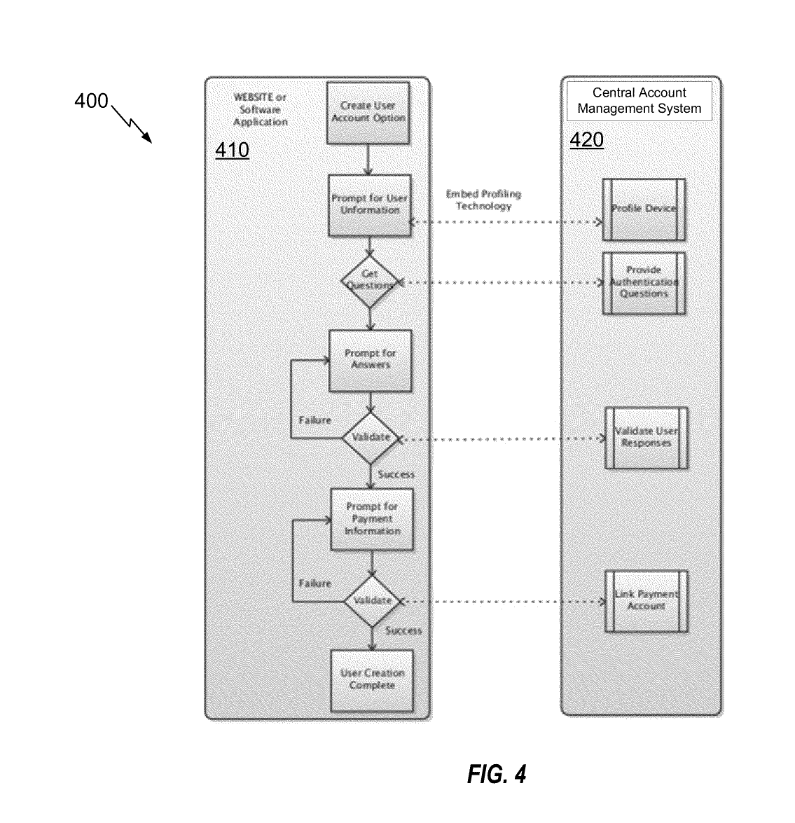

NEW USER REGISTRATION PROCESS: With reference to FIG. 4, there is shown an embodiment of a system 400 for registering a new user. For example, the system 400 may include an online service or software application 410 and a central account management system 420 for performing a new user registration process.

General aspects of the new user registration process may include one or more of the following: embedding the device profiling technology into the user profile creation process; tracking the time it takes to complete the process; tracking the position of the clicks on the buttons; detecting automated account creations scripts; risk based authentication to validate first time account creation; setting up multiple forms of authentication for return user account verification (e.g., email, short message service (SMS), phone calls, secure token mobile app, voice recognition, facial recognition, retinal recognition, video/picture based authentication, mutual authentication allowing the user to select an image which will be used on subsequent logins wherein the user is expected to enter their account details only when the selected image is displayed, etc.); pre-defined conditions wherein certain profiling characteristics have different levels of initial account verification; and/or the like.

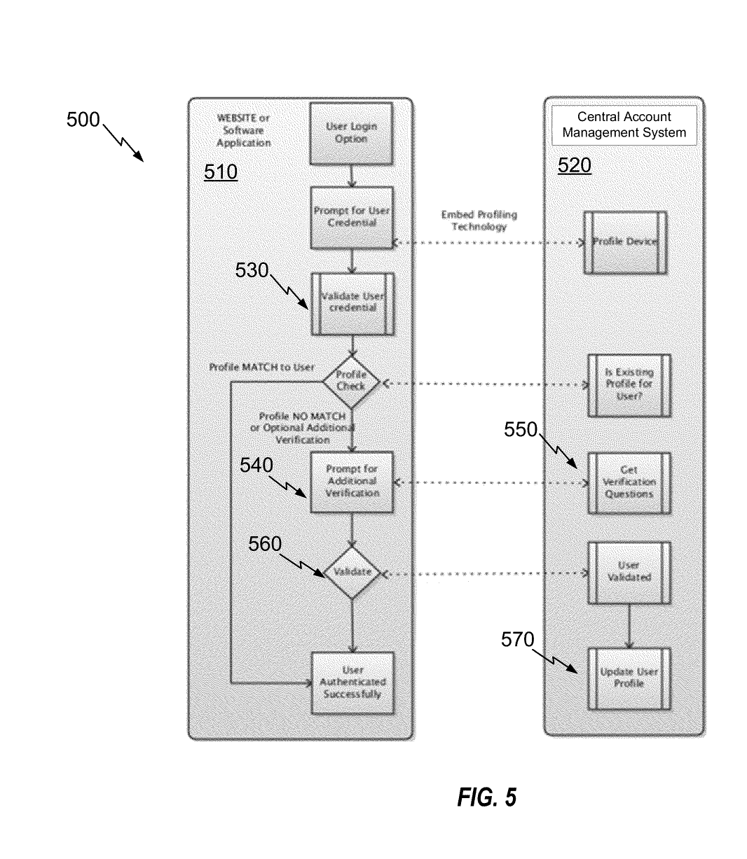

With reference to the example system 400 of FIG. 4, the Operator online service (or software application) 410 may enable the user to create a user account in order to participate in online wagering. During the user creation process, the Operator online service 410 may integrate with the central account management system 420 enabling the central account management system 420 to collect user information, compare information to existing user profiles, register the user, authenticate the user, and/or enable the user to fund their profile account with the Operator 410. It is noted that the Operator 410 may collect the user information and submit it to the central account management system 420 for processing. In the alternative, or in addition, the central account management system 420 may directly collect the user information. It is further noted that the system 420 may include or be a Partner instance 130 (not shown) of the central account management system 420 (see FIGS. 1-2). The Partner instance 130 of the system 420 may interface the Operator 410 and/or other network entities (e.g., payment network(s) or the like) of the system 400. Similarly, the central account management systems shown in FIGS. 5-10 may also include one or more Partner instances 130 that interface with the Operator(s), payment network(s), and/or other network/system entities.

RETURNING USER AUTHENTICATION: With reference to FIG. 5, there is shown an embodiment of an illustrative system 500 for returning user authentication. For example, the system 500 may include an online service or software application 510 and a central account management system 520 for performing a returning user authentication process. During the returning user authentication process, the Operator website 510 may integrate with the system 520, thereby enabling the collection of user information by the system 520 for purposes of user identification and authentication. The Operator 510 may employ their own user authentication techniques at 530, as well as leverage the system 520 for additional user authentication at 540. In the event that the returning user is using an unregistered device or is from an unrecognized location, secondary user account verification steps may be taken to verify the identity and location of the returning user. The system 520 may leverage internal data or external data to support the user authentication process at 550. In this embodiment, the system 520 may return the outcome of the user authentication at 560 to the Operator's website or software application 510, and may update the user's profile at 570 within the system 520.

General aspects of the returning user authentication process may include one or more of the following. Device profiling technology may be embedded into the returning user authentication process. User authentication and profile association may be performed during the user login process. Once the user is successfully logged into the Operator's application/website 510, the user's activity may be recorded as part of the user's profile. The user may be promoted for their user identification and verification credentials. The user may be optionally prompted for additional forms of verification, and may involve risk based authentication (e.g., out of pocket questions), secondary forms of authentication (e.g., ID verification, voice verification), etc.

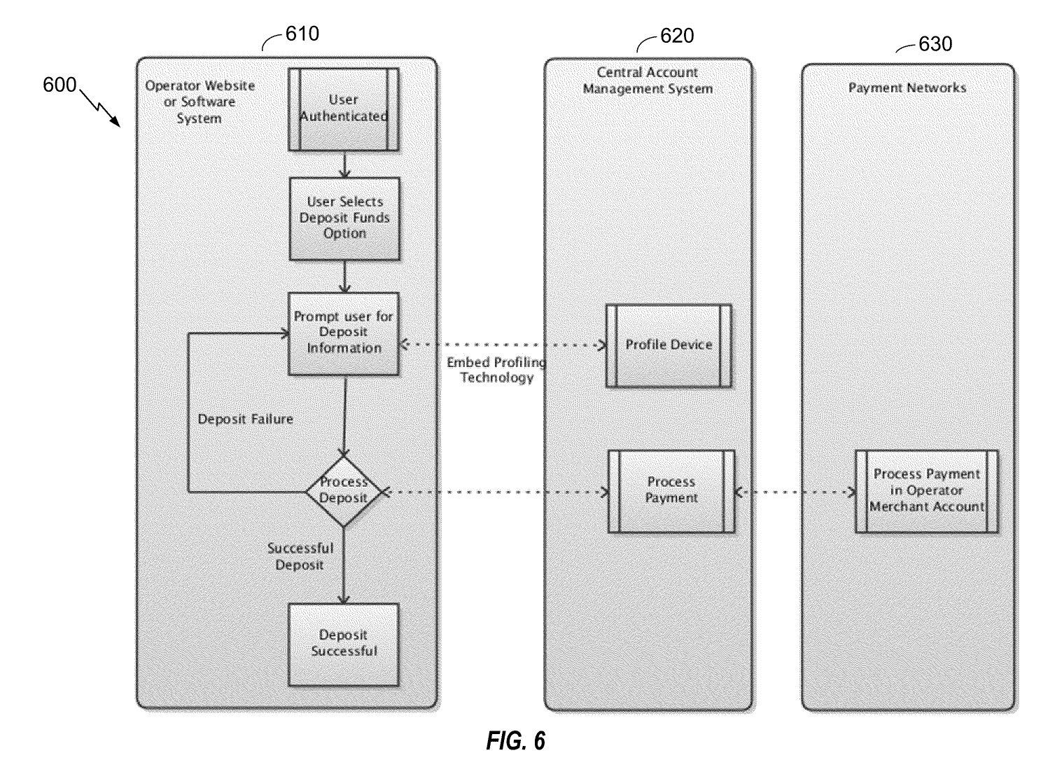

OPERATOR USER ACCOUNT FUNDING: With reference to FIG. 6, there is shown an embodiment of a system 600 that includes an Operator system 610, a central account management system 620, and payment network(s) 630. The Operator system 610 may authenticate a new or returning user(s). A given user may select the deposit funds options from the Operator system 610. For example, the Operator system 610 may prompt the user for deposit information. The central account management system 620 may facilitate the processing of payment transaction between the user and the Operator 610. The system 620 may accept the user payment information from the Operator 610 and may process the request with the Operator's merchant account payment processor or the like at the payment network(s) 630. In another approach (not shown), the system 620 may directly interface with the user on behalf of the Operator 610 to collection payment information and to facilitate the payment transaction with the payment networks(s) 630 or the like.

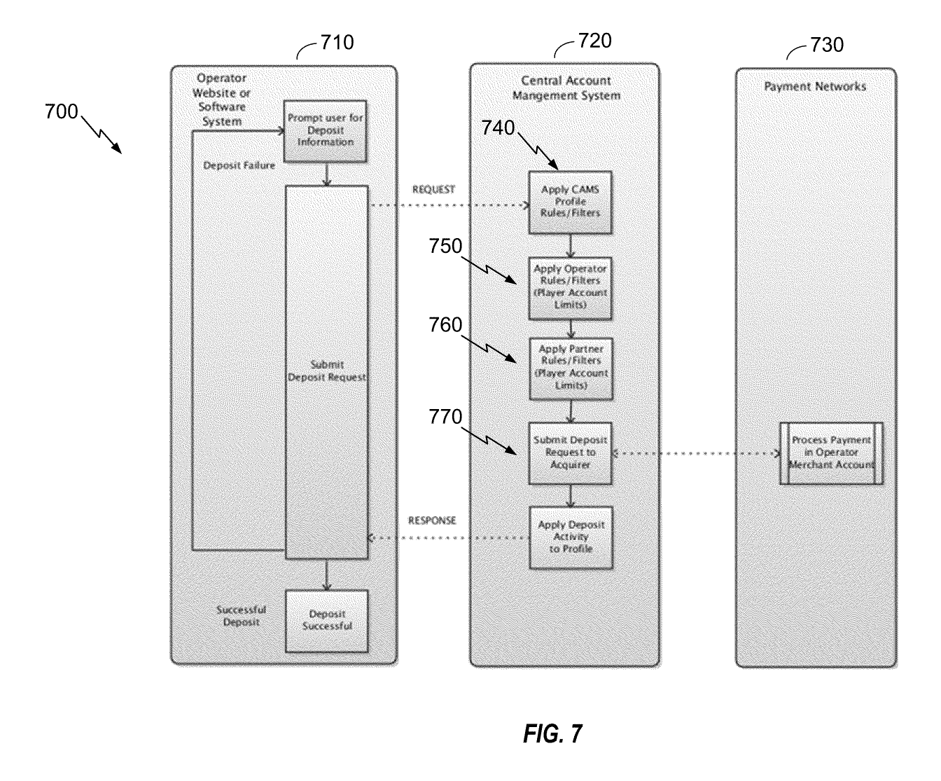

DEPOSIT PAYMENT PROCESS: With reference to FIG. 7, there is shown an embodiment of a system 700 that includes an Operator system 710, a central account management system 720, and payment network(s) 730. In response to receiving a deposit request from the Operator system 710, the central account management system 720 may apply one or more profile rules or filters at 740. The system 720 may apply Operator rules/filters at 750. The system 720 may apply Partner rules or filters at 760, such as, for example, at least one player account limit (PAL) or the like. The system 720 may submit a deposit request at 770 to a merchant account acquirer payment processor or the like at the payment network(s), and may apply a deposit activity to the user profile.

In related aspects, the system 720 may apply one or more PALs. For example, there may be one or more levels of account limit configurability: user-defined; Operator-defined; and/or Partner-defined. The user-defined PAL may include self-exclusion, personal user limits, limits of deposits within a pre-determined time period, or the like. The deposit activity may be associated with the user profile and be applied across a plurality of one or more payment instruments, rather than an individual credit card number or the like.

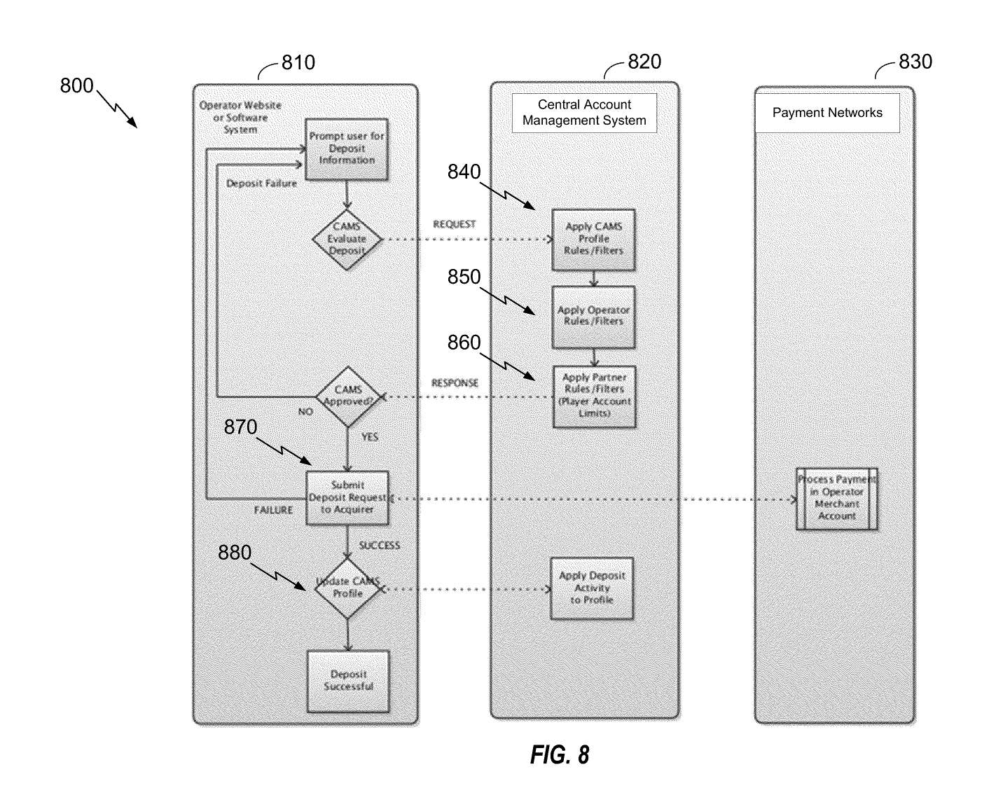

DEPOSIT SEQUENCE: With reference to FIG. 8, there is shown an embodiment of a system 800 that includes an Operator system 810, a central account management system 820, and payment network(s) 830. In the illustrated example of FIG. 8, the central account management system 820 does not provide payment connectivity to the banking networks. It is noted that the system 820 may apply one or more PALs. As noted above, there may be one or more levels of account limit configurability: user-defined at 840; Operator-defined at 850; and/or Partner-defined at 860. The user-defined PAL may include self-exclusion, personal user limits, limits of deposits within a pre-determined time period, or the like. The Operator system 810 may submit a deposit request at 870 to the merchant account payment processor or the like at the payment network(s), and may apply a deposit activity at 880 to the user profile.

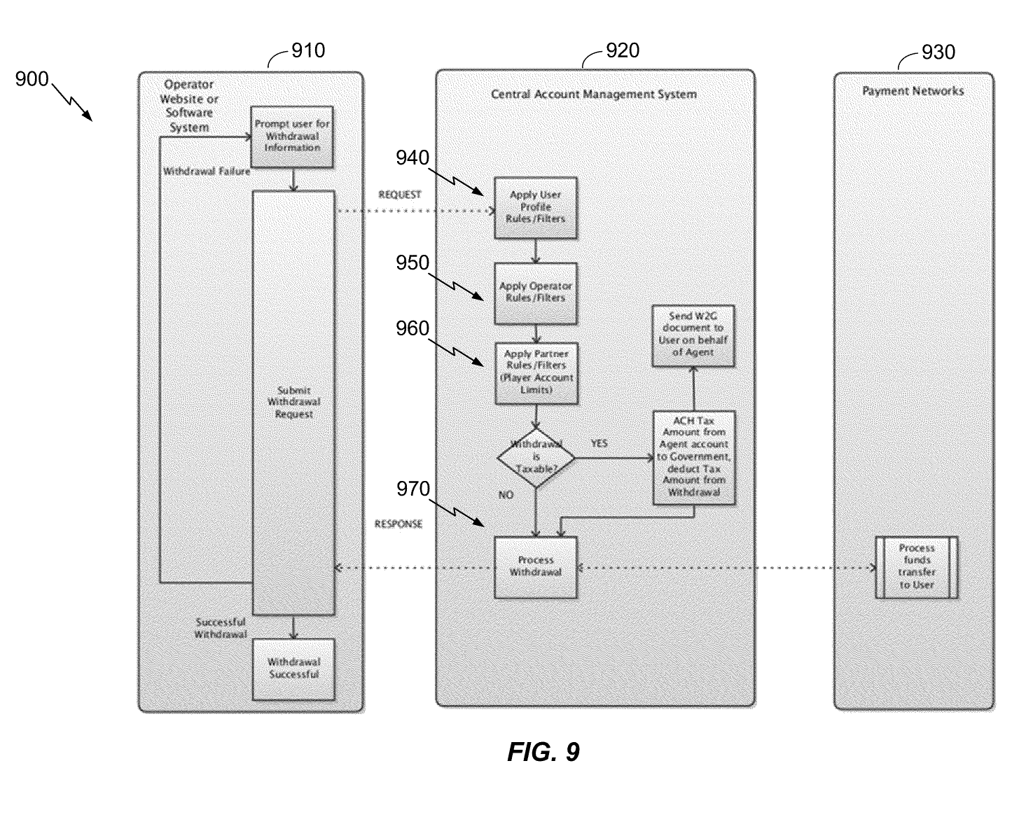

WITHDRAWAL PROCESS: With reference to FIG. 9, there is shown an embodiment of a system 900 that includes an Operator system 910, a central account management system 920, and payment network(s) 930. In response to receiving a withdrawal request from the Operator system 910, the system 920 may apply one or more user profile rules or filters a 940. The system 920 may apply Operator rules/filters at 950. The system 920 may apply Partner rules or filters at 960, such as, for example, at least one PAL or the like. The system 920 may submit a withdrawal request at 970 to the merchant account payment processor or the like at the payment network(s). The outcome of the withdrawal request may be returned to the Operator system 910.

Compliance and enforcement of tax withholdings (e.g., state and/or federal, U.S. and/or other countries) may be implemented by the system 900 at the Operator 910 and/or at the Partner level. Withdrawals (funds transferred from the Operator 910 to user/consumer) may be transferred to one or more bank/financial accounts, and may be split across one or more financial instruments. Depending on regulatory requirements, a portion (partial or full) of the withdrawal maybe executed by reversing the original charge/deposit of the credit card transaction, original deposit transaction, or the like.

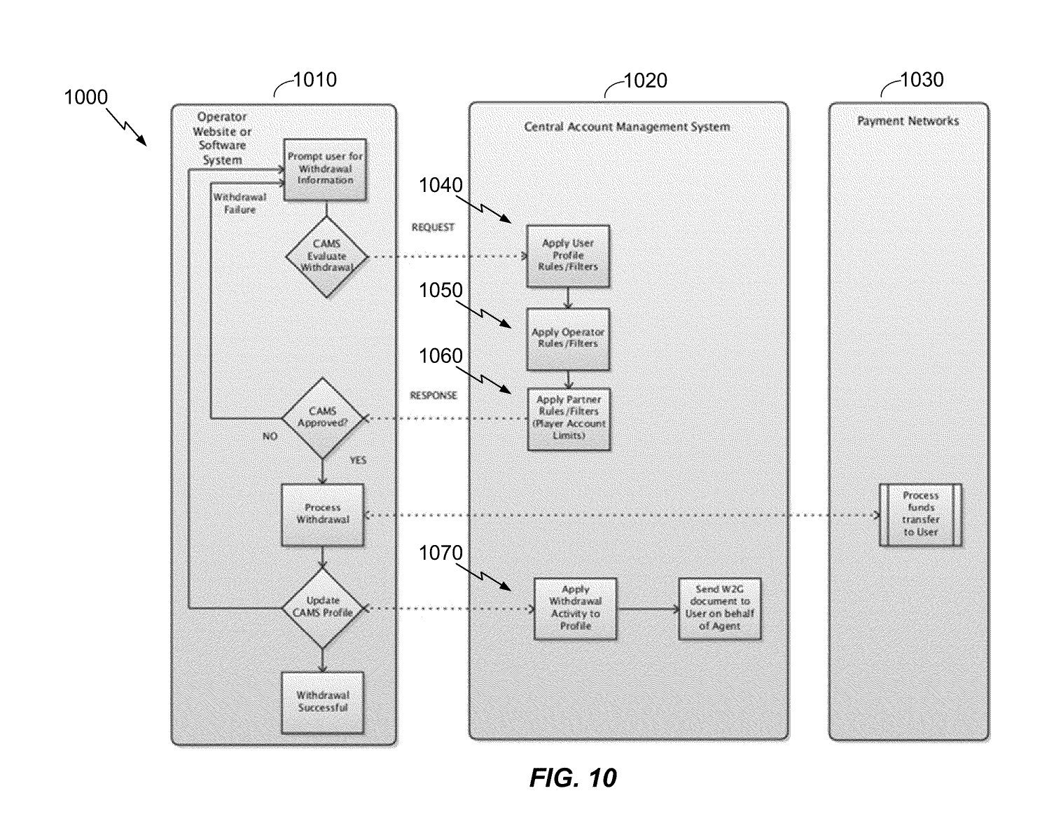

WITHDRAWAL PROCESS, WHEN THE SYSTEM IS NOT PROVIDING PAYMENT CONNECTIVITY TO THE BANKING NETWORKS: With reference to FIG. 10, there is shown an embodiment of a system 1000 that includes an Operator system 1010, a central account management system 1020, and payment network(s) 1030. The system 1020 may apply one or more PALs or the like. For example, there may be one or more levels of account limit configurability, such as, for example: user-defined at 1040; Operator-defined at 1050; and/or Partner-defined at 1060. The user-defined PAL may include self-exclusion, personal user limits, limits of deposits within a pre-determined time period, or the like. The Operator system 1010 may submit a funds transfer request to the merchant account payment processor or the like at the payment network(s), and may notify the central account management system 1020 of the withdrawal activity at 1070 to the user profile.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram

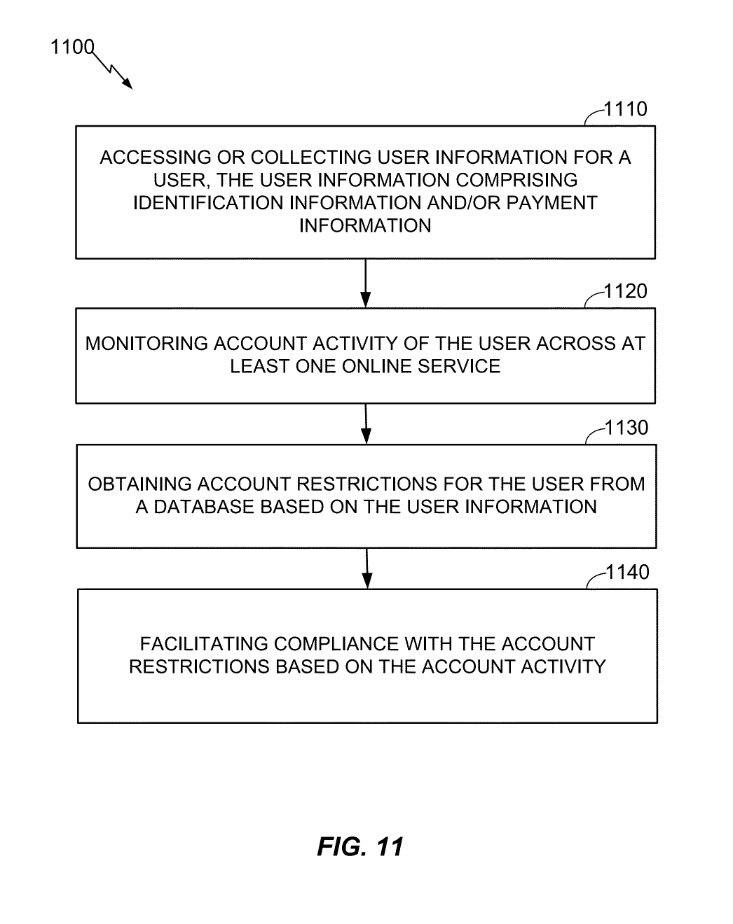

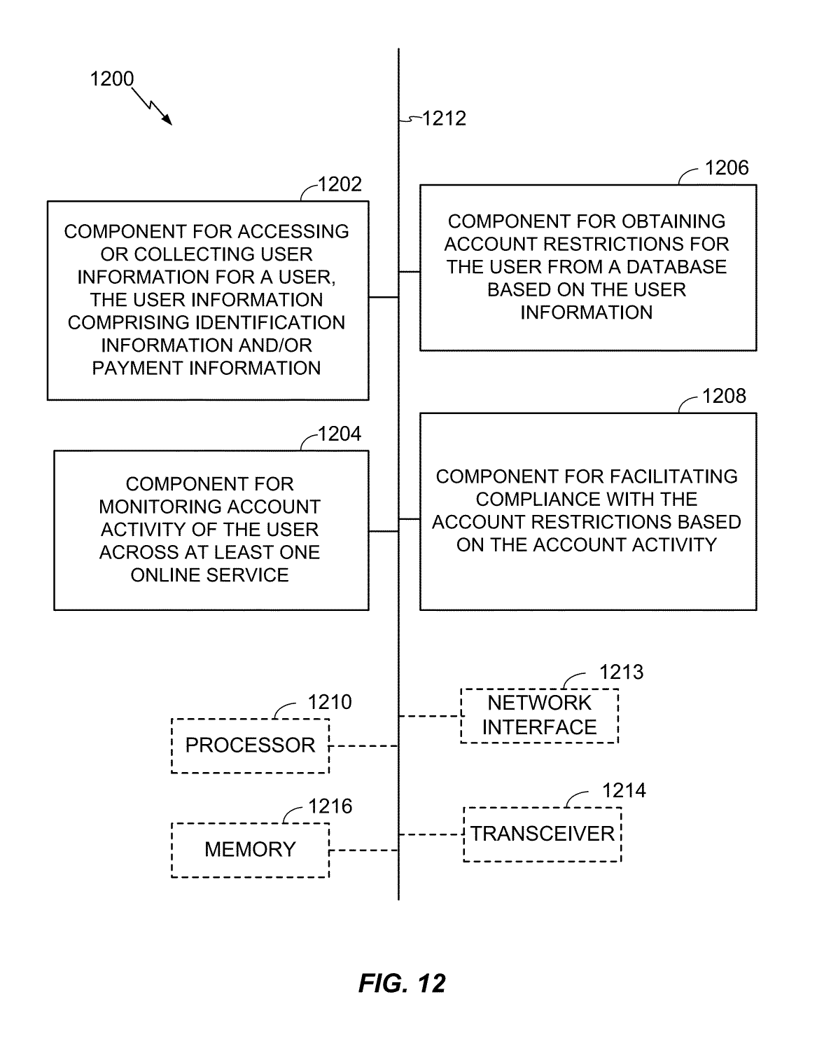

In accordance with one or more aspects of the embodiments described herein, there is provided a technique operable by at least one network entity (e.g., at least one server or the like) for managing an online service account. For example, the at least one server may include a multi-tenant SaaS component or the like. With reference to the example of FIG. 11, there is shown a methodology 1100 that may involve accessing or collecting user information for a user (e.g., collecting the user information from the user or a third-party entity), the user information comprising identification information and/or payment information (block 1110). For example, block 1110 may be performed by a processor working in conjunction with a network interface and/or transceiver (e.g., the processor 1210, the network interface 1213, the transceiver 1214, and/or the component/module 1202 in FIG. 12). The method 1100 may involve monitoring account activity of the user across at least one online service (block 1120). For example, block 1120 may be performed by a processor (e.g., the processor 1210 and/or the component/module 1204 in FIG. 12).

The method 1100 may involve obtaining account restrictions for the user from a database based on the user information (block 1130). For example, block 1130 may be performed by a processor working in conjunction with a network interface and/or transceiver (e.g., the processor 1210, the network interface 1213, the transceiver 1214, and/or the module/component 1206 in FIG. 12). The method 1100 may involve facilitating compliance with the account restrictions based on the account activity (block 1140). For example, block 1140 may be performed by a processor and a memory (e.g., the processor 1210, the memory 1216, and/or the component/module 1208 in FIG. 12).

In related aspects, the user information may be locally stored at the network entity. The method 1100 may further involve gathering the user information to setup or update the online service account. In the alternative, or in addition, the user information may be stored on at least one remotely located server or the like.

In further related aspects, the identification information may include at least one of a social security number, driver's license number, government ID, a passport number, voiceprint, fingerprint, facial print, retinal print, hand print, credit score data, tax return data, background check data, personally identifiable information (PII), a user device ID, and geo-location data for the user.

In yet related aspects, the payment information may include at least one of credit or debit card account number, checking account data, alternative payment methods, pre-paid account data, e-commerce payment account data, LEC billing data, digital wallets, alternative payment data, instant banking, local exchange carrier (LEC) billing data, mobile billing data, near field communication (NFC) account data, casino-operator specific account data, casino credit data, social networking service specific credits, or other forms of digital currency.

In still related aspects, monitoring (block 1120) may involve tracking user's transactions at the at least one online service. Monitoring (block 1120) may involve communicating locally with a multi-tenant SaaS component or the like using synchronous and asynchronous methods. In the alternative, or in addition, monitoring (block 1120) may involve communicating with at least one remote server, the at least one remote server comprising an online service server or a payment processor server.

In related aspects, the database with the account restrictions may be stored locally at the network entity. In the alternative, or in addition, the database with the account restrictions may be stored on a remote server or the like. For example, the database with the account restrictions may be stored on the server operated by a government agency, a gamblers anonymous service, a credit monitoring service, or a law enforcement agency. In another example, the server with the database may be operated by an accredited third-party.

In further related aspects, the account restrictions may include at least one of an age limit, an outstanding balance limit, a number of transactions limit, and a defined deposit limit for a defined time period. Facilitating compliance (block 1140) may involve, in response to the account activity exceeding at least one limit of the account restrictions, notifying at least one of (a) the user, (b) the at least one online service (c) a gamblers anonymous service, (d) user's payment processor, (e) an enforcement entity, and (f) a Partner instance entity, regarding the user exceeding the at least one limit The method 1100 may further involve maintaining a list of gamblers who have failed to comply with their respective account restrictions, the list being local to the network entity or stored in a remote database that is accessed by the network entity.

In yet further related aspects, the method 1100 may further involve obtaining tax liability/compliance information from the at least one online service or at least one tax agency, the tax liability information relating to state tax liability or federal tax liability. For example, the at least one tax agency may be the Internal Revenue Service (IRS). The method 1100 may further involve communicating with the at least one online service or at least one tax agency to facilitate the payment of taxes by the user.

In still further related aspects, the at least one online service may include at least one gambling service, and the online service account be a gambling account. The at least one online service may include a lottery site or a gaming site, and the online service account may be a lottery account or a gaming account.

In accordance with one or more aspects of the embodiments described herein, there are provided devices and apparatuses for managing online service accounts, as described above with reference to FIG. 11. With reference to FIG. 12, there is provided an exemplary apparatus 1200 that may be configured as a network entity (e.g., a specialized server) in an online or mobile network, or as a processor or similar device for use within the network entity. The apparatus 1200 may include functional blocks that can represent functions implemented by a processor, software, or combination thereof (e.g., firmware). The methodologies and techniques shown in FIG. 11 or described with direct or indirect reference to FIG. 11 may be performed by one or more of the components shown in FIGS. 1-10 and 12 or otherwise described herein.

As illustrated, in one embodiment, the apparatus 1200 may include an electrical component or module 1202 for accessing or collecting user information for a user, the user information comprising identification information and/or payment information. The apparatus may include a component 1204 for monitoring account activity of the user across at least one online service. The apparatus may include a component 1206 for obtaining account restrictions for the user from a database based on the user information. The apparatus may include a component 1208 for facilitating compliance with the account restrictions based on the account activity.

In related aspects, the apparatus 1200 may optionally include a processor component 1210 having at least one processor, in the case of the apparatus 1200 configured as a network entity, rather than as a processor. The processor 1210, in such case, may be in operative communication with the components 1202-1208 via a bus 1212 or similar communication coupling. The processor 1210 may effect initiation and scheduling of the processes or functions performed by electrical components 1202-1208.

In further related aspects, the apparatus 1200 may include a network interface 1213 and/or a transceiver component 1214. A stand alone receiver and/or stand alone transmitter may be used in lieu of or in conjunction with the transceiver 1214. The apparatus 1200 may optionally include a component for storing information, such as, for example, a memory device/component 1216. The computer readable medium or the memory component 1216 may be operatively coupled to the other components of the apparatus 1200 via the bus 1212 or the like. The memory component 1216 may be adapted to store computer readable instructions and data for effecting the processes and behavior of the components 1202-1208, and subcomponents thereof, or the processor 1210, or the methods disclosed herein. The memory component 1216 may retain instructions for executing functions associated with the components 1202-1208. While shown as being external to the memory 1216, it is to be understood that the components 1202-1208 can exist within the processor 1210 and/or the memory 1216.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method operable by a network entity for managing an online service account, comprising:
accessing user information for a user, the user information comprising identification information or payment information;
monitoring account activity of the user across at least one online service;
obtaining account restrictions for the user from a database based on the user information; and
facilitating compliance with the account restrictions based on the account activity.

2. The method of claim 1, wherein the network entity comprises at least one server that comprises a multi-tenant Software as a Service (SaaS) component for performing at least one of the accessing, the monitoring, the obtaining, or the facilitating.

3. The method of claim 1, wherein the user information is locally stored at the network entity.

4. The method of claim 3, further comprising gathering the user information to setup or update the online service account.

5. The method of claim 1, wherein the user information is stored on at least one remotely located server.

6. The method of claim 1, wherein the identification information comprises at least one of social security number, driver's license number, government ID, passport number, credit score data, tax return data, background check data, personally identifiable information (PII), a user device ID, voiceprint, fingerprint, casino-operator specific account data, or geo-location data for the user.

7. The method of claim 1, wherein the payment information comprises at least one of credit or debit account number, checking account data, pre-paid account data, digital wallet data, alternative payment data, local exchange carrier (LEC) billing data, mobile billing data, near field communication (NFC) account data, or casino-operator specific account data.

8. The method of claim 1, wherein monitoring comprises tracking user's transactions at the at least one online service.

9. The method of claim 1, wherein monitoring comprises communicating locally with a multi-tenant Software as a Service (SaaS) component.

10. The method of claim 1, wherein monitoring comprises communicating with at least one remote server, the at least one remote server comprising an online service server or a payment processor server.

11. The method of claim 1, wherein the database with the account restrictions is stored locally at the network entity.

12. The method of claim 1, wherein the database with the account restrictions is stored on a remote server.

13. The method of claim 12, wherein the database with the account restrictions is stored on the remote server operated by a government agency, a gamblers anonymous service, a credit monitoring service, or a law enforcement agency.

14. The method of claim 1, wherein the account restrictions comprise at least one of an age limit, a location of player, an outstanding balance limit, a number of transactions limit, or a defined deposit limit for a defined time period.

15. The method of claim 14, wherein facilitating compliance comprises, in response to the account activity exceeding at least one limit of the account restrictions, notifying at least one of (a) the user, (b) the at least one online service (c) a gamblers anonymous service, (d) user's payment processor, (e) an enforcement entity, or (f) a partner instance entity, regarding the user exceeding the at least one limit.

16. The method of claim 14, further comprising maintaining a list of players who have failed to comply with their respective account restrictions, the list being local to the network entity or stored in a remote database that is accessed by the network entity.

17. The method of claim 1, further comprising obtaining tax liability information from the at least one online service or at least one tax agency, the tax liability information relating to state tax liability or federal tax liability.

18. The method of claim 17, wherein the at least one tax agency comprises the Internal Revenue Service (IRS).

19. The method of claim 17, further comprising communicating with the at least one online service or at least one tax agency to facilitate the payment or reconciliation of taxes by the user.

20. The method of claim 1, wherein:
the at least one online service comprises at least one online gaming service; and
the online service account comprises a gaming account.

21. The method of claim 1, wherein:
the at least one online service comprises a lottery service or a gaming service; and
the online service account comprises a lottery account or a gaming account.

22. The method of claim 1, wherein accessing comprises collecting the user information for the user.

23. A method operable by a network entity for managing an online gambling account, comprising:
accessing user information for a user, the user information comprising identification information or payment information;
monitoring account activity of the user across at least one online gambling service;
obtaining gambling restrictions for the user from a database based on the user information; and
facilitating compliance with the account gambling restrictions based on the account activity.

24. An apparatus, comprising:
means for accessing user information for a user, the user information comprising identification information or payment information;
means for monitoring account activity of the user across at least one online service;
means for obtaining account restrictions for the user from a database based on the user information; and
means for facilitating compliance with the account restrictions based on the account activity.

25. An apparatus, comprising:
at least one processor configured to: access user information for a user, the user information comprising identification information or payment information; monitor account activity of the user across at least one online service; obtain account restrictions for the user from a database based on the user information; and facilitate compliance with the account restrictions based on the account activity; and
a memory coupled to the at least one processor for storing data.

26. The apparatus of claim 25, wherein the apparatus comprises at least one server that comprises a multi-tenant Software as a Service (SaaS) component.

27. A computer program product, comprising:
a non-transitory computer-readable medium comprising code for causing a computer to:
access user information for a user, the user information comprising identification information or payment information;
monitor account activity of the user across at least one online service;
obtain account restrictions for the user from a database based on the user information; and
facilitate compliance with the account restrictions based on the account activity.
